(19) United States
(12) Patent Application Publication
(10) Pub. No.: US 2008/0071631 A1
(43) Pub. Date: Mar. 20, 2008

(54) Marketplace, an easy way to manage your e-needs

(76) Inventor: Nagendra Nagarajayya, (US)

Correspondence Address: Transaxtions LLC, 4302 Denker Dr, Pleasanton, CA, 94588, US

(21) Appl. No.: 11/532,539

(22) Filed: Sep. 18, 2006

(51) Int. Cl. G06Q 30/00

(52) U.S. Cl. 705/26

(57) ABSTRACT

Every presence has needs. A need could be consumer electronics, loans, autos, or knowledge, etc. The marketplace with an intelligent search engine allows the presence to become knowledgeable about a need and buy the need in multiple ways.

### FIELD OF THE INVENTION

The present invention relates to a marketplace for e-commerce on the intranet and the internet. Marketplace with an intelligent search engine enables a user to manage ones e-needs online by providing a marketplace with a competitive process, guiding information with guide selections, multiple ways to shop, and to search the marketplace as well as the internet to find products, market information, competitive and comparative information.

### BACKGROUND OF THE INVENTION

Buying online is just at its infancy and has no geographical borders and barriers. A person in the US to a person in Singapore, China or India could be buying online from the same merchant at the same time. Comscore the well known market research firm said that cumulative online buying reached $10.2 billion between November 1 to December 15, with the peak on December 12 reaching sales of $218 million for non travel related items. This is an increase of 32% over 2001. So 2005 should see at the same growth, about $23 billion in online sales—non travel related sales. This is just during the holiday season. Online sales for 2004 exceeded $117 billion with sales for non-travel related increasing to $66.5 billion, an increase of 26% over 2003.

According to Comscore users typically start their buying process at the search engines with generic terms like “lcd tv” to become knowledgeable. They then proceed offline to a store, etc. to get information about the product, followed by a latent search session or proceed directly to their favorite retailer to buy the product. The latent search session is still generic terms such as “lcd tv” and only a few percentage move to product specific terms such as “Panasonic or Sony LCD TV TC-32LX60”. Comparative search is another favorite way users search, compare and become knowledgeable about products and prices.

Internet auctions are also popular and allow a buyer to bid on a product online. A buyer might pay a lot more when similar products are available in stores. Prof. Richard Freeman, co-director of the “Centre for Economic Performance at the London School of Economics” and Harvard professor, is looking at user behavior at internet auctions. He warns that users get excited and often bid too high called the winner's curse. In Christmas 2000, Sony Playstations were being sold at inflated prices at internet auctions while High Street stores were selling it at reasonable prices. Cautionary tales abound of hapless shoppers unable to control their obsession and caught in bidding wars for items that they did not want. In a New York Times piece, Michelle Slatalla confesses of buying an item for $2300 when she set out to buy a used system for $800. Reverse auctions on the other hand allow the buyer to set a price and bidding to be initiated by the sellers. But a buyer not knowing the market information can set too high a price for a product and buy at above market prices. A Buyer in an auction might not be very knowledgeable about an item, or if the item is a popular item, or the market information for the item like the low price or average price for a region. They have to do their own research and end up buying items that they might not need or paying a high price for it instead of a reasonable price. Reverse Auctions also introduce deterioration in buyer/seller relationship due to falling prices.

Users search for generic terms like “lcd tv” or “laptop computer” or “mortgage loan” and sometime specific terms such as “Taco Bell” or “Panasonic TV” and expect to get information related to finding the restaurant “Taco Bell”, or buying a “Panasonic TV” or a “Laptop computer” or information about a “mortgage loan”. A user searching for “Panasonic TV” expects to see the popular models, models on sale, market competitive information, information about TVs, LCD TVs, etc. A user searching for a “Laptop computer” is interested in knowing more about a laptop computer, a computer, different models on sale, popular selections, market information, etc. For a “mortgage loan” or “need a mortgage loan” the user might be interested in, what is a mortgage loan?, types of loan products, current interest rates, different mortgage brokers, bankers, market competitive information, etc. A user searching for “relief from cough” or “tantrums 10 yr old” is looking to find information related to relief from a cough or how to overcome the tantrums thrown by the 10 yr old. The search engines with natural language ability do try to understand the context but again might not present the information needed by the user.

A definite need exists for a marketplace with an intelligent search to solve the problems associated and described above. Guiding Information, patent pending U.S. application Ser. No. 11/161,897 provides expert information about a category and sub category along with market competitive information. Guide Info tabs with Guide Selections patent pending application Ser. No. 11/308,093, Intelligent Search patent pending application Ser. No. 11/306332, Popular IDs to Sign On patent pending application Ser. No. 11/162,735 help in solving the problems described above. The primary purpose of the present invention is to solve these needs building on the above patent pending inventions and to provide further, related advantages.

### BRIEF DESCRIPTION OF THE INVENTION

Every presence has needs. A need could be consumer electronics, loans, autos, or knowledge, etc. The presence uses search engines, marketplaces, etc. to become knowledgeable about the need and if needed purchase the need. The invention allow a user to become knowledgeable about the market through guiding information and guide selections, searching online, browsing, etc. and allows the user to buy a need in multiple ways.

### BRIEF DESCRIPTION OF THE DRAWINGS

The accompanying drawings, which are incorporated into and constitute a part of this specification, illustrate one or more embodiments of the present invention and, together with detailed description, serve to explain the principles and implementations of the invention.

FIG. 1 is an illustration of ENeedsOnline marketplace.

FIG. 2 is an illustration of a user click on a category with a search attribute.

FIG. 3 is an illustration of a user click on a category with a tree attribute.

FIG. 4 is an illustration of a user click on a link in FIG. 3.

FIG. 5 is an illustration of a user click on a link in FIG. 4.

FIG. 6 is an illustration of a user click on a link in FIG. 5.

FIG. 7 is an illustration of a user click on a link in FIG. 5 allowing a user to post a need to the competitive market.

FIG. 8 is an illustration of a store view.

FIG. 9 is an illustration of a click on a link in FIG. 8.

FIG. 10 is an illustration of a click on a link in FIG. 9.

FIG. 11 is an illustration of a user searching the product marketplace.

FIG. 12 is an illustration of a user searching for a product on the internet.

FIG. 13 is an illustration of a follow on session by a user searching for a product.

FIG. 14 is an illustration of the search results with guiding information and guide selections.

### REFERENCES CITED

U.S. PATENT DOCUMENTS

| | | | |
|---|---|---|---|
| 7069242 | June, 2006 | Sheth, et al. | 705/37 |
| 6161099 | December, 2000 | Harrington, et al. | 705/36R |
| 6101482 | August, 2000 | Dingell, et al. | 705/26 |

### U.S. Published Applications

| | | |
|---|---|---|
| 20020120522 | August, 2002 | Yang, Chen-Shi |
| 20020023046 | February, 2001 | Callahan, Patrick; et al. |

### Other References

www.consumerreports.org, ratings and reports

www.shop.com, shopping portal with a universal cart

www.bizrate.com, comparison shopping portal

Comscore Research Report, “Consumers Again Break Online Spending Record, Reaching $2.2 Billion, Reports Comscore”, Dec. 17, 2002

Comscore Research Report, “Vast Majority of Search-influenced Buying Occurs Either Offline or in Subsequent Internet User Sessions”, Dec. 13, 2004

Comscore Research Report, “In An Age Of Unprecedented Consumer Expectations, Retailers Must Eliminate Remaining Barriers Between Shopping Channels”, Jan. 19, 2005

### Parents Case Text

### Public Disclosure

The invention was first disclosed to the public at the SVASE, breakfast club event in Oakland on Oct. 13, 2005. http://www.eneedsonline.com was made available as an open beta to the public on Nov. 14, 2005. Features described in the invention were being made available to the public through the open beta as of the filing date of this application.

### Cross-Reference to Related Applications

This application references U.S. patent application Ser. No. 11/308,093, titled “Guiding Info Tabs With Guide Selections” filed Mar. 6, 2006 by the present applicant.

This application references U.S. patent application Ser. No. 11/306332, titled “Intelligent Search With Guiding Info” filed Dec. 22, 2005 by the present applicant.

This application references U.S. patent application Ser. No. 11/161,897, titled “Obtaining A Need With Guiding Information And Credit Worthiness Using A Competitive Process” filed Aug. 22, 2005 by the present applicant.

This application references U.S. patent application Ser. No. 11/162,735, titled “Using Popular IDs To Sign On Creating A Single ID For Access” filed Sep. 21, 2005 by the present applicant.

### DETAILED DESCRIPTION OF PREFERRED EMBODIMENTS

Embodiments of the present invention are described herein in the context of a method and apparatus for emulating a competitive process. Those of ordinary skill in the art will realize that the following detailed description of the present invention is illustrative only and is not intended to be in any way limiting. Other embodiments of the present invention will readily suggest themselves to such skilled persons having the benefit of the disclosure. Reference will now be made in detail to the implementations of the present invention as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application and business related constraints, and that these specific goals will vary from one implementation to another and from one developer to another. Moreover, it will be appreciated that such a development effort might be complex and time consuming, but would nevertheless be routine undertaking of engineering for those of ordinary skill in the art having the benefit of this disclosure.

In accordance with the present invention, the components, process steps, and/or data structures may be implemented using various types of operating systems, computing platforms, computer programs, and or/general purpose machines. In addition, those of ordinary skill in the art will recognize that devices of a less general purpose nature such as hardwired devices, field programmable gate arrays (FPGAs), application specific integrated circuits (ASICs), or the like, may also be used without departing from the scope and spirit of the inventive concepts disclosed herein.

The purpose and idea of the invention is to provide an online marketplace with an intelligent search engine with guiding information and guide selections to allow a presence to become knowledgeable about a need and be able to buy the need in multiple ways. The invention also allows a presence to communicate and collaborate.

Guiding info (patent pending application Ser. No. 11/161,897) an expert engine presents easy and understandable information about a particular category and sub category, using tabs to associate a guiding info section, each tab having a color and a code, and maybe guide selections. Guide selections (patent pending Ser. No. 11/308,093) are popular choices of products and information that enables a user to make an easy selection. The products could be consumer products like Televisions, MP3 or IPODs, Mortgage Loans, Mobile Phones and their plans, Autos and Auto Loans, etc. Intelligent Search (patent pending Ser. No. 11/306,332) is an intelligent search engine that uses returns from popular search engines, vertical portals, hidden web, intelligent indexing, Guiding Info, to present semantically correct and relevant results. Single ID (patent pending Ser. No. 11/162,735) uses popular IDs to sign on activating presences associated with the id.

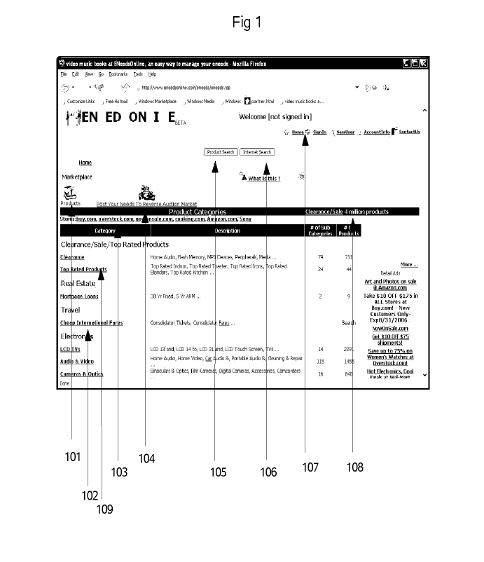

FIG. 1 is an illustration of ENeedsOnline.com home page. The figure illustrates a marketplace, a search engine, products, reverse auction marketplace, stores, etc. 101 is the Product View and shows products available in the marketplace. A user can buy a product in multiple ways by searching, comparing, posting the need to the reverse auction marketplace, using the “Buy Now” link to buy immediately or Buy using the store view. 102 shows a category, the category is a search mechanism, 109 shows a category with sub categories and products. 103 shows a list of stores that can be accessed from a Store View. 104 is the link to “Post A Need To The Reverse Auction Market Place”, a user can post a need to a reverse auction marketplace for competitive bidding. 105 is the product search button for searching within the marketplace, 106 is the internet search button for searching on the internet, 107 is the sign-on mechanism, 108 shows the number of the products in the market place.

According to Comscore, a user looking for a product usually starts with a search at the search engines and then goes offline and usually follows up with a return search session to get more information, compare prices and either buys it online or goes offline to buy. The marketplace is designed to build on this and provides an intelligent search engine that can be used to search within the marketplace or on the internet. The search engine uses a feedback mechanism, weighting a user interest as more important than other results shown. This weighting allows it to rank the user interest as more relevant than other results. When the user does a follow on search in another session, the most relevant results are shown first, and since the user links are weighted, they get to the top of the search, making it easier for the user to continue the buying or getting information process. The search results could be associated with guiding information and guide selection, see U.S. patent application Ser. No. 11/308,093, which would allow the user to get more information and maybe even buy immediately instead of continuing with the search. A user instead of using 106 might start with 105 to search for products. 105 is a search within the marketplace and allows the user to get guiding information with guide selections, buy immediately, compare prices or post a need for a product to the competitive marketplace. Users usually like to compare prices before buying. They also like guiding information and guide selections to become knowledgeable about a product. The 1109 “Compare Prices” link allows the user to compare prices and buy from the lowest priced store. The 1108 “Buy Using Reverse Auction” link allows a user to post the need for a product to the competitive market place, see U.S. patent application Ser. No. 11/161,897, for more information. The 1110 “Buy Now” link allows the user to buy immediately from a store. Another research from Comscore shows that users like to buy directly from their favorite stores. The Store view 103 allows a user to buy from their favorite store.

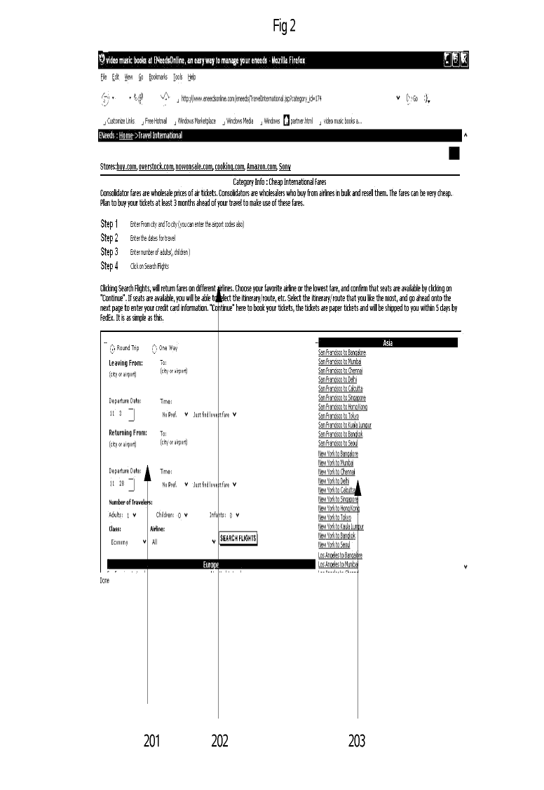

FIG. 2 is an illustration of a user click on a category with a search attribute. This takes the user to a search mechanism that can be used to query for more information, compare prices maybe with guiding information and guide selections, buy now options, etc. 201 is a query form for retrieving International airfares. 202 is the guiding information for the category. 203 is more options allowing the user to retrieve fares to their favorite destinations. The guiding information and guide selections in the embodiment do not show “Buy Now”, “Compare Prices” or “Buy Using Reverse Auction” options but this could be included in other embodiments. The feedback and memory mechanism is shown only for the internet search in this embodiment but could be available for the product search in other embodiments. The product search and internet search shown separately in the embodiment could be made as one in other embodiments.

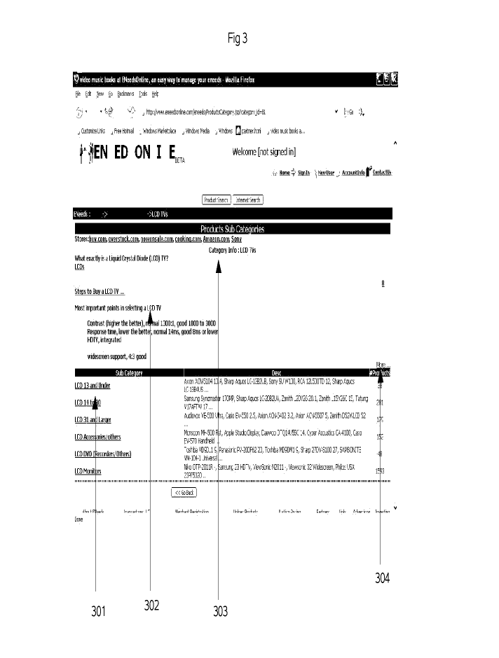

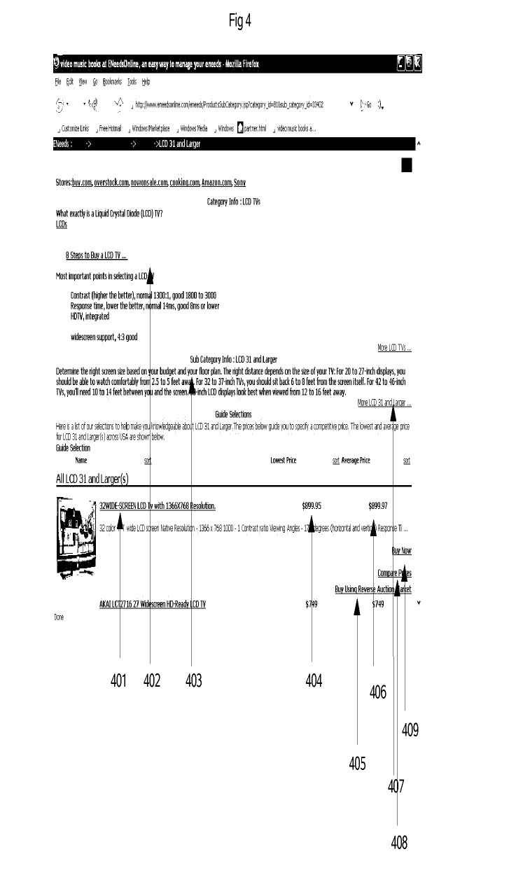

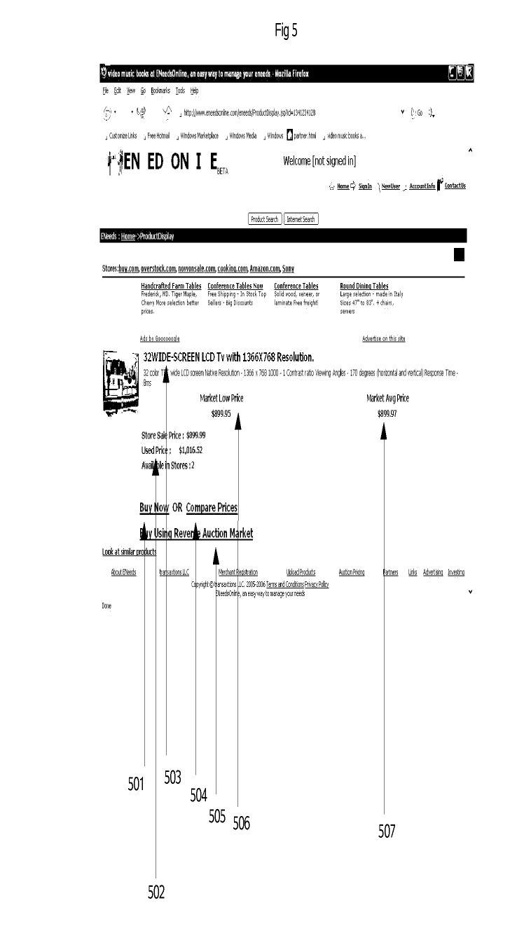

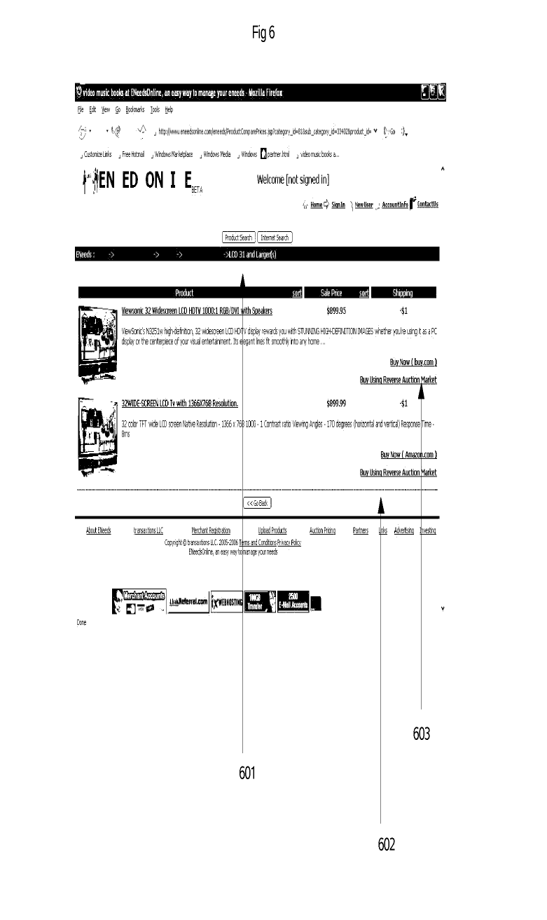

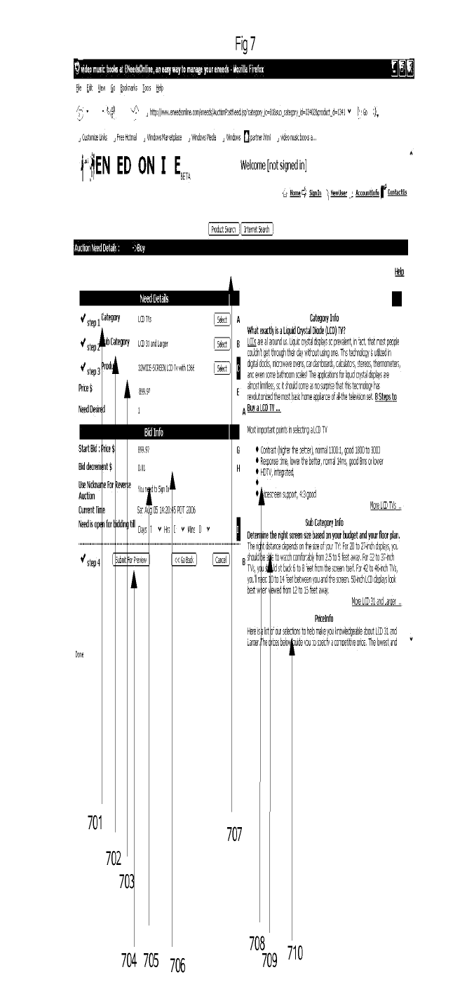

FIG. 3 is an illustration of a user click on a category with a tree attribute. This takes the user to a list of sub categories. 301 is the list of sub categories under the category, 302 is the guiding information for the category, 303 is the category name, 304 is the number of products in each sub category. FIG. 4 is an illustration of a user click on the “LCD 31 and larger” sub category. There are no guide selections for this particular category but it has guiding information. 401 is a product in this category, 402 is the guiding information for the category, 403 is the guiding information for this sub category, 407 provides more information about the sub category, 404 is the market low price of 401, 405 is the average price for 401 in the marketplace, 405, 408, 409 are different options available to a user. 408 allows the user to compare prices, 409 allows the user to “Buy” the product immediately, while 405 allows the user to post the need for such a product to the reverse auction market place for competitive bidding. FIG. 5 is an illustration of a user click on link 401, providing more details to the user. This could be information about the product, like “Sale Price”, “Msrp”, “Used Price”, “Refurbished Price”, “Discount”, “Rebate”, etc., technical and product specs, similar products options, compare options, market information like low price, average price for the product, number of sellers, other market related information, making the user knowledgeable about the product. 501 is a “Buy Now” option allowing the user to buy from a merchant immediately, 502 shows the sale price, msrp, used price, discount, rebate available, number of stores, etc., 503 is the name of the product, this could be an hyperlink providing technical and product specs, etc., 504 is a compare prices option allowing the user to compare prices, 505 allows the user to post the need to a reverse auction marketplace for competitive bidding, 506, 507 provide market information to the user like the low price, average price, number of stores, product ranking, popularity, etc., FIG. 6 is an illustration of an user click on 504, compare prices option providing information about the product from different stores and their prices, shipping, rebates, used prices, refurbished prices, etc. 601 is the compare products window, 602 shows product from a store while 603 shows it from a different store. FIG. 7 is an illustration of a user click on 505 allowing the user to post a need for the product to the reverse auction market for competitive bidding. 701 is category information (step 1), 702 is the sub category information (step 2), 703 is the need name (step 3), 704 is the option to preview and post the need (step 4), 705 and 706 are populated automatically and can be changed by the user as needed, 707 is the “Post Need For Bidding” window, 708, 709, 710 provide guiding information with guide selections. Clicking on 704 allows the user to preview the information and post the item to the marketplace for bidding. The merchants bid on the posted need and the merchant with the lowest price wins the bid to sell to the buyer, see U.S. patent application Ser. No. 11/161,897 for more information.

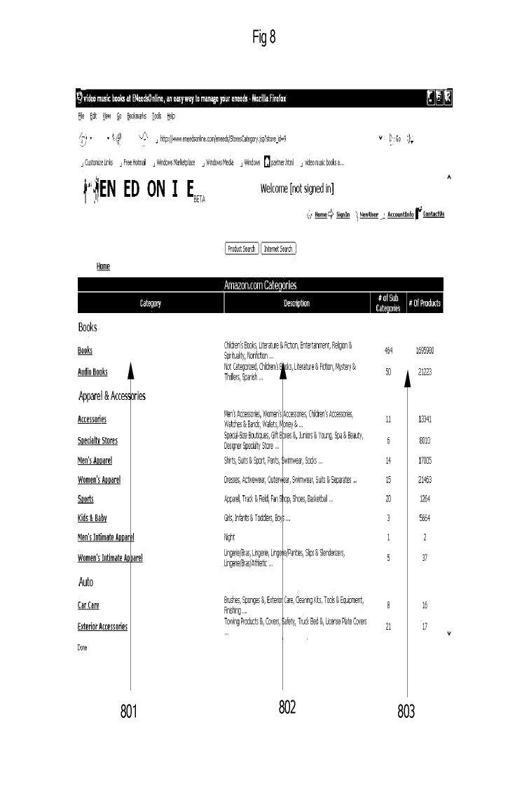

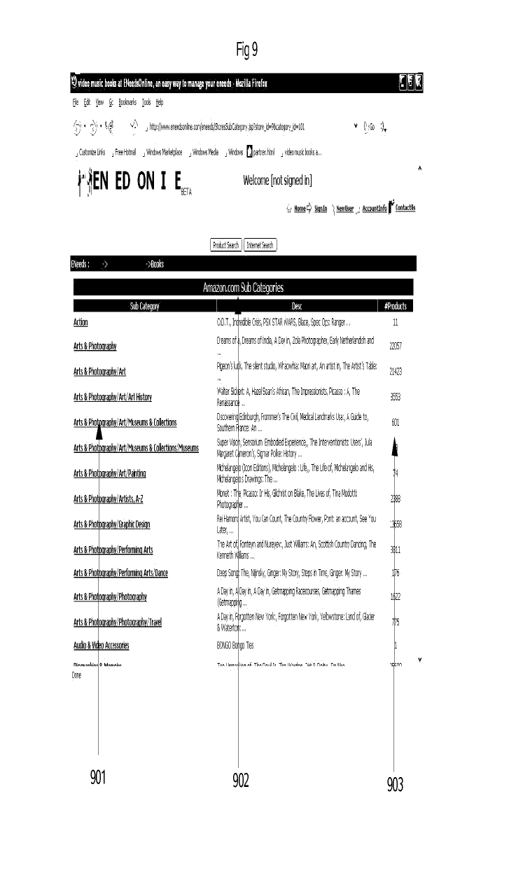

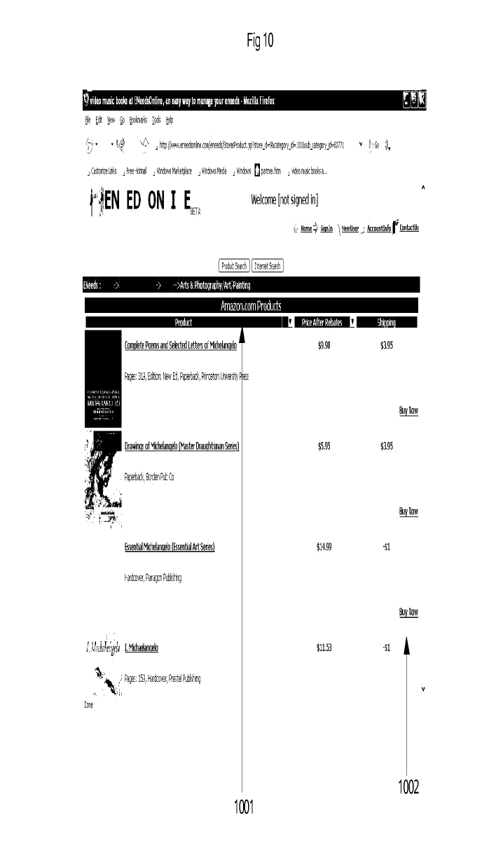

FIG. 8 illustrates the “Store View”, allowing the user to buy from their favorite store. 801 the categories available, 802, 803 provide more information about the categories like sub category, number of products, etc. FIG. 9 illustrates a user click on a link in 801. 901 is the sub categories and 902, 903 provide more information about the sub category and the products available. FIG. 10 illustrates a user click on a link shown in 901. 1001 and 1002 show the products available and the prices for the products. The price shown is the lowest price and could include other information such as used price, refurbished price, shipping, etc.

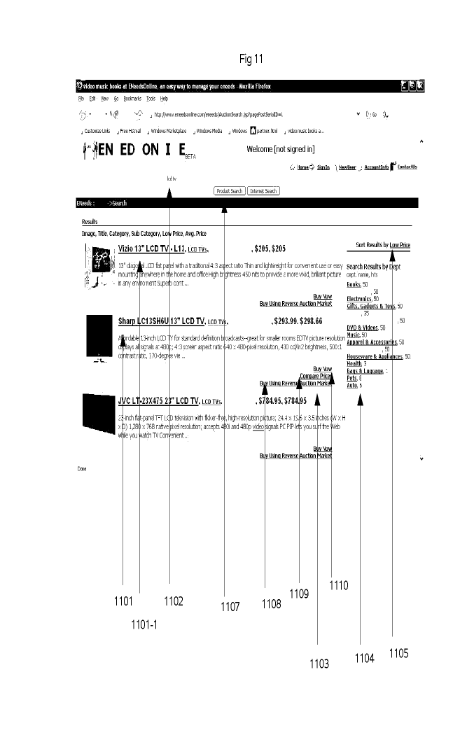

FIG. 11 illustrates a user searching for a product in the marketplace. 1102 is the search term entered by the user. 1107 is the product search button, clicking on this button shows the results in FIG. 11. 1101 are relevant results returned, 103 are the options available to the user to “Buy Now”, “Compare Prices”, “Buy Using Reverse Auction”. The attributes shown could be different for each search result and might include other options or leave out options as needed. 1101-1 is a result without the compare prices option. 104 is the search result by departments, 1105 allows the results to be sorted with low price, first.

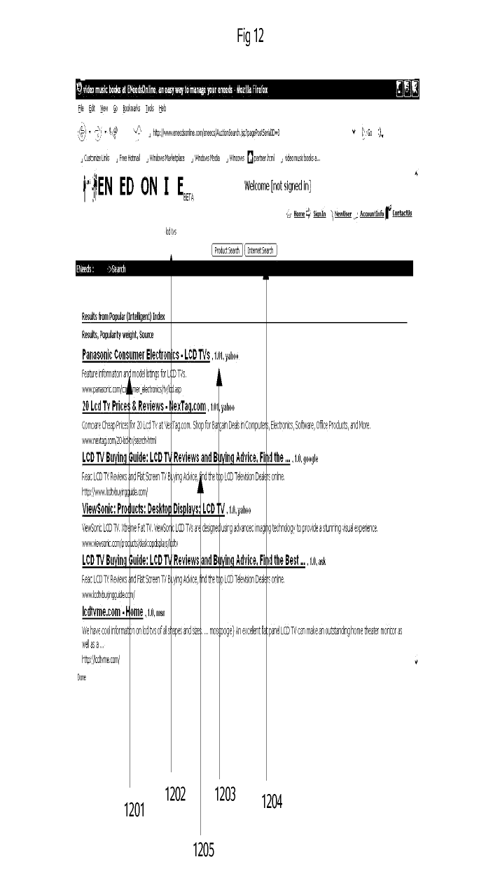

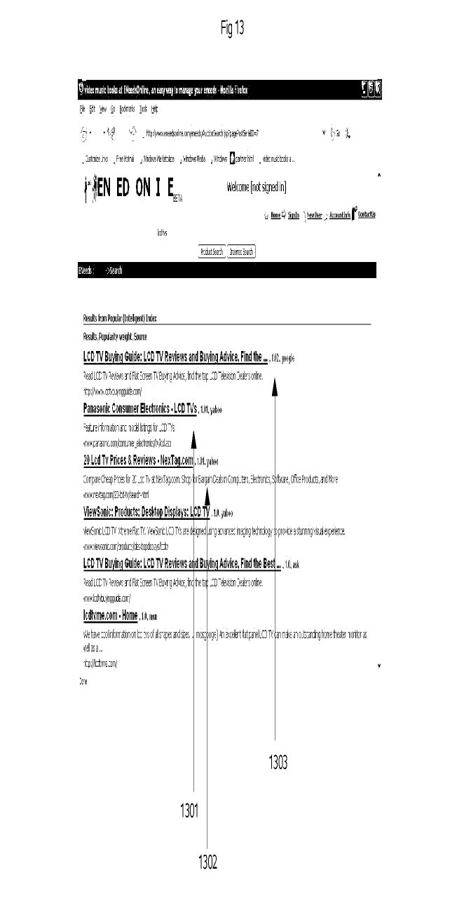

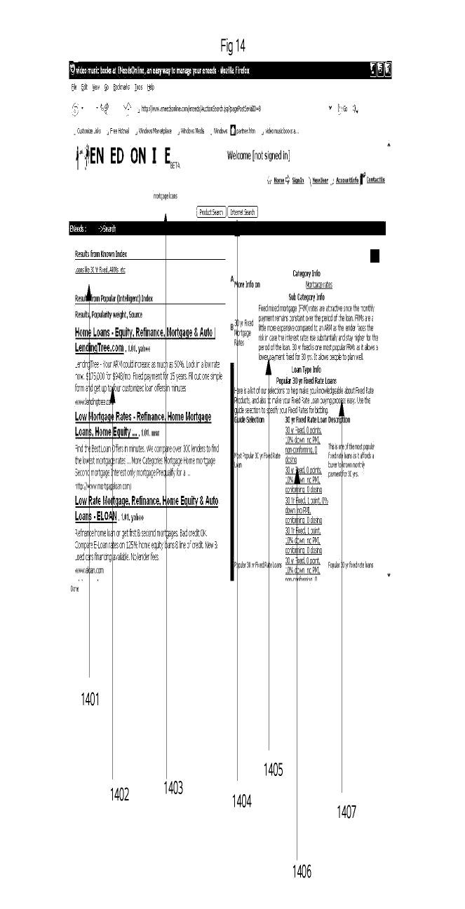

FIG. 12 illustrates a user searching for a product or a need on the internet. 1202 is the search term entered by the user. 1204 is the internet search button, clicking on this button shows the results in FIG. 12. 1201 is the relevant results returned, 1203 is the weight associated with a result, 1205 is the link that a user wants to click on to get more information about “lcd tvs”. Clicking on 1205 takes the user to a website that provides information on LCD Tvs, rankings, buying lcd tvs, etc. FIG. 13 illustrates a follow on search session by the user with the same query term. Comscore research shows that users use simple search terms like “lcd tv” to start a search before buying a product and continue to use the same search term in the follow on session to get more information or to even start the buying process. 1303 is the same link 1205 but now ranked first with a weight showing its popularity. The user on the follow on session finds the link that provided the information about “lcd tvs” ranked first but also shows the user the popularity of that particular link allowing the user to get more information or continue on with the buying process. 1301 and 1302 are the results shown in 1201 but now ranked a little lower as 1303 has become popular. FIG. 14 illustrates search results with guiding information and guide selections. 1403 is the search term, 1404 is the same 1204, clicking on the button shows the results in the FIG. 14. 1401 is the known index, 1402 is the unknown index, 1405, 1406 and 1407 show guiding information and guide selections for the category/sub category (see U.S. patent application Ser. No. 11/306332 for more details) related to the search term.

It should be noted that this is an illustration of one of the embodiments. A buyer need to experience a product visually or physically is what leads a buyer usually to go offline after an initial search. A buyer familiar with a product might make repeated buys without going offline. Embodiments not shown in this disclosure can be added to the marketplace to create this experience following a search like using a satellite to zoom down on to a product to see a 360 visual of the product or presenting the buyer with a 360 degree 3D visual of the product to visually experience the product. This experience will lead a buyer to follow a search to a compare with guiding information and guide selections, and maybe to an immediate buy either using the competitive process or using the store or product view “buy now” options.

FIG. 1 is an illustration of the marketplace product view. This view is the default view and is shown when a user accesses the website URL. The user access of the URL is transferred to eneeds.jsp, which instantiates the controller ProductsCategoryController. The first time this controller is accessed, the initialize method gets called which adds the controller as a pagelistener, enabling the pageRequested method to get control whenever a page is visited by a user. The pageRequested invokes the super.pageRequested method to execute the BaseController pageRequested method. This checks if the user is a valid user and if the user has logged in, showing a welcome message and other user related status. A PrinterWriter object is instantiated with a StringWriter to render the page. The DatabaseUtil and the Util objects are instantiated next. The Util.showStores method is invoked to render the list of stores 103 after having rendered the navigation status bar 106. The cache is checked next to see if this page has been viewed by a user before—the first time a user accesses this page, the contents are retrieved from the database and the contents are cached. The next access is retrieved from the cache instead of the database to increase the performance. Cache.getPage (Cache.PRODUCT_CATEGORIES, “getProductCategories”) is used to check the cache and if it does not exist, the product categories are retrieved from the database by executing a SQL query. The retrieved categories are cached, using Cache.addToCache (Cache.PRODUCT_CATEGORIES, “getProductCategories”) and then rendered to show name, number of sub categories, and products 102 and 109. 101, 104, 105, 106, 107, 108 are set from banner.jsp page. eneedsTemplateBefore.jsp and eneedsTemplateAfter.jsp are templates used to show the header and footer information and is invoked from within eneeds.jsp.banner.jsp is invoked from eneedsTemplateBefore.jsp.banner.jsp is part of all pages shown.

Entering a search term “lcd tv” and clicking on “Product Search” 105 will invoke the marketplace Product Search mechanism, which will search through the products available within the marketplace and show the most relevant results. A click on 105 will transfer control to AuctionSearch.jsp. The first time this is invoked, AuctionSearchController is instantiated and the initialize method is called. This method adds two listeners the pagelistener and a form, _pageFormBanner, submit listener. The submitPerformed method gets invoked when the user clicks on the “Product Search” button. The AuctionSearchController handles both the “Internet Search” and the “Product Search”, and a check is made to see if the button is the “Product Search” button, and if so, the Session Manager is used to store the search term into a property named “search”, if it is the “Internet Search” button, the search term is stored in a property named “isearch”. The control is next transferred to the pageRequested method to render the page. In the pageRequested method, a check Is made to see if the “search” or “isearch” property is set. If the “search” property is set, search.AuctionSearch.getSearchObject is used to retrieve a cached instance of an AuctionSearch instance, an instance of com.transaxtions.auction.Search is created and the getAuctionIndexResults method is invoked. getAuctionIndexResults invokes, search.getAuctionIndexResultsMultiIndex to actually query the search indexes to get the most relevant results. The results from search.getAuctionIndexResultsMultiIndex are returned in a ResultAuctionIndex object from which a SearchObjectHolder array is retrieved. The ResultAuctionIndex object is persisted to disk for performance. The array is iterated to access individual elements, which contain documents. In the first iteration, the ResultAuctionIndex.getLowPriceTS method is accessed to retrieve the results sorted by low price and departments. These TreeSets are persisted on disk for performance. The document fields, image, text, description, URL, “compare prices”, “buy now”, “buy using reverse auction” are rendered. The departments and “sorted by low price” link are shown on the right. If the user clicks on these links, the persisted TreeSets are read, and the documents are rendered as above. Entering a search term “lcd tv” and click on “Internet Search” 106 will transfer control to AuctionSearch.jsp. AuctionSearch.jsp instantiates an AuctionSearchController, if one has not yet been instantiated, and will transfer control to the submitPerformed method of the controller as in 105. The “isearch” property is set and when pageRequested method is activated, the test for “isearch” property is true so the control now gets transferred to displaylSearch method. displaylSearch calls cgels.com to get the internet search results. Cgels.com is the intelligent search engine as described in invention U.S. patent application Ser. No. 11/306,332. The result returned by cgels.com is copied on to the html page. The results include search results from known index, unknown index and semantic index. The results could also include guiding information with guide selections.

A click on any of the links in the Product View like 103 transfers control to ProductCategory.jsp which instantiates the ProductSubCategoryController to render the sub categories under the category link. Clicking on any of the sub category links transfers control to ProductsSubcategory.jsp which instantiates the ProductsAvailableController to render the products under the sub category. The products available for a particular category are cached by running GenGuidingInfo application. GenGuidingInfo generates an xml file with attributes for each product like name, id, global_part_num, store_id, low_price 404, avg_price 406, etc. The xml file is rendered by the ProductsAvailableController which invokes the ProductInfoXml.drawCategoryNode 402, ProductInfoXml.drawSubCategoryNode 403, ProductInfoXml.drawNeedRateNode 401 to display the xml data as html as in FIG. 4. Clicking on 409 transfers the buyer to the merchant site so that the product can be purchased immediately. The transfer is done by invoking ProductForward.jsp which instantiates the ProductForwardController. The pageRequested method in ProductForwardController gets activated, a lookup is made to lookup the parameter id from a database. Control is transferred to the merchant buy URL using sendRedirect method. Clicking on 408 transfers the buyer to a compare prices page. The transfer is done by invoking ProductComparePrices.jsp which instantiates the ProductComparePrices controller. The ProductComparePrices controller looks up at the global_id and retrieves the products belonging to this id, showing their prices, shipping costs, etc., see FIG. 6. Clicking on 405 transfers the buyer to the reverse auction marketplace. The transfer is done by invoking AuctionPostNeed.jsp.AuctionPostNeed.jsp instantiates AuctionPostNeedController and the pageRequested method is activated. The category, sub category and product id parameters are obtained from the query string. The category, sub category information is retrieved from the database using the DatabaseUtil object. The product id is used to obtain the product information like name, low and average price. The need_rate is set to the average price 703, the start bid rate is also set to the average price 706. The buyer can preview the need to be posted to the market by clicking on 704 and if everything looks Ok, post the need to the market for bidding. The merchants can bid on this need, with each bid being lower than the last bid.

It should be noted that in the described embodiments, an object oriented programming environment has been described to discuss the present invention. Object Oriented Constructs such as methods, object, attribute, exceptions have been used to describe how the invention works. However, this can also be implemented in other programming environments and languages. It should also be noted that this is an illustration of one of the embodiments. The elements can be retrieved using other methods, and rendered or passed on to other methods or objects, and should not be limited to as shown.

While embodiments and applications of this invention have been shown and described, it would be apparent to those skilled in the art having benefit of this disclosure that many more modifications than mentioned above are possible without departing from the inventive concepts herein. The invention, therefore, is not to be restricted except in the spirit of the appended claims.

Definition List 1

| Term | Definition |
|---|---|
| GET | A HTTP method to send/get data from a |
| | server |
| POST | A HTTP method to send/get data from a |
| | server |
| HTTP | A TCP/IP based text request/response |
| | protocol that allows web browsers to show |
| | data from a server called a web server |
| Session | A J2EE HTTP session object, and provides a |
| | way to identify a user across more than one |
| | page request or visit to a Web site and to |
| | store information about that user. |
| J2EE | Java 2 Platform, Enterprise Edition defines |
| | the standard for developing component- |
| | based multitier enterprise applications |
| Jsp | JavaServer Pages technology provides a |
| | simplified, fast way to create dynamic web |
| | content |
| Salmon Open Source | An open source MVC J2EE server framework |
| Framework | for building J2EE applications |
| URL | Uniform Resource Locator |
| XML | Extensible Markup Language |
| TCP | Transmission Control Protocol |
| IP | Internet Protocol |
| Java | An object oriented programming language |
| MVC | Model View Controller paradigm |
| Web | World wide web, www, also known as the |
| | internet |
| Browser | A Graphical User Interface for viewing |
| | content called html on the web |
| ENeedsOnline | An online marketplace where buyers and |
| | sellers can make available a need, |
| | http://www.eneedsonline.com |

What is claimed is:

1. A method for searching, browsing, collaborating, communicating and buying on the internet or intranet in a computer based system, the method comprising:
Providing a marketplace with a search mechanism with feedback and memory; said marketplace provides multiple ways for a buyer to buy a need, provides a product view, a competitive process view and store view; said marketplace with search mechanism provides guiding information and guide selections for a buyer to become knowledgeable about a product and the market; said marketplace and search mechanism can be used to buy, compare prices or post a need to a competitive market; said marketplace provides a competitive process for a buyer to post a need for bidding.

2. A method according to claim 1 wherein a buyer uses said search mechanism to become knowledgeable about a need; said search mechanism uses feedback to weight results; said feedback with weights act as memory; said feedback with memory enables search results to be ranked higher in follow on sessions; said search results could be associated with guiding information and guide selections; wherein said guiding information is the market information about a product such as low and average price, and said guide selections are popular selections of products such as most popular, popular, prudent, starter and high end; said search results allow a buyer to buy, compare prices or post the need to a competitive market place.

3. A method according to claim 1 wherein said marketplace offers multiple ways for a buyer to buy a need; said multiple ways includes searching product market place to find, compare, buy or post need to the competitive process or searching on the internet to become knowledgeable about a product; said multiple ways includes a product view with guiding information and guide selection providing market competitive information, comparing prices, posting need to a competitive process or buying immediately; said multiple ways includes buying from a store view; said multiple ways includes buying from the competitive process view which is a reverse auction process.

4. A method according to claim 1 wherein said store view shows products from a merchant, provides option to buy from the merchant, said marketplace with store view provides the buyer access to their favorite stores and to buy from there.

5. A method according to claim 1 wherein said competitive process view allows a need to be posted to a competitive market with a reverse auction process with guiding information and guide selections; said reverse auction process allows a plurality of sellers to bid on the need, each bid lower than the last bid, and allows the buyer to buy at a reasonable price.

6. A program storage device readable by a machine, tangibly embodying a program of instructions readable by a machine to perform a method of searching, browsing, collaborating, communicating and buying on the internet or intranet; said method provides a marketplace with a search mechanism with feedback and memory; said marketplace provides multiple ways for a buyer to buy a need, provides a product view, a competitive process view and store view; said marketplace with search mechanism provides guiding information and guide selections for a buyer to become knowledgeable about a product and the market; said search mechanism can be used to buy, compare prices or post a need to a competitive market; said marketplace provides a competitive process for a buyer to post a need for bidding.

7. A program storage device according to claim 6 wherein a buyer uses said search mechanism to become knowledgeable about a need; said search mechanism uses feedback to weight results; said feedback with weights act as memory; said feedback with memory enables search results to be ranked higher in follow on sessions; said search results could be associated with guiding information and guide selections; wherein said guiding information is the market information about a product such as low and average price, and said guide selections are popular selections of products such as most popular, popular, prudent, starter and high end; said search results allow a buyer to buy, compare prices or post the need to a competitive market place.

8. A program storage device according to claim 6 wherein said marketplace offers multiple ways for a buyer to buy a need; said multiple ways includes searching product market place to find, compare, buy or post need to the competitive process or searching on the internet to become knowledgeable about a product; said multiple ways includes a product view with guiding information and guide selection providing market competitive information, comparing prices, posting need to a competitive process or buying immediately; said multiple ways includes buying from a store view; said multiple ways includes buying from the competitive process view which is a reverse auction process.

9. A program storage device according to claim 6 wherein said store view shows products from a merchant, provides option to buy from the merchant, said marketplace with store view provides the buyer access to their favorite stores.

10. A program storage device according to claim 6 wherein said competitive process view allows a need to be posted to a competitive market with a reverse auction process with guiding information and guide selections; said reverse auction process allows a plurality of sellers to bid on the need, each bid lower than the last bid, and allows the buyer to buy at a reasonable price.

11. An apparatus for searching, browsing, collaborating, communicating and buying on the internet or intranet; the apparatus comprising:
Marketplace;
Search mechanism;
Product, Store, Competitive process views;
Reverse auction process;
Guiding Information;
Guide Selections;
Said marketplace with a search mechanism with feedback and memory provides multiple ways for a buyer to buy a need, provides a product view, a competitive process view and store view; said marketplace with search mechanism provides said guiding information and said guide selections for a buyer to become knowledgeable about a product and the market; said search mechanism can be used to buy, compare prices or post a need to a competitive market; said marketplace provides a said competitive process for a buyer to post a need for bidding.

12. An apparatus as in claim 11 wherein a buyer uses said search mechanism to become knowledgeable about a need; said search mechanism uses feedback to weight results; said feedback with weights act as memory; said feedback with memory enables search results to be ranked higher in follow on sessions; said search results could be associated with guiding information and guide selections; wherein said guiding information is the market information about a product such as low and average price, and said guide selections are popular selections of products such as most popular, popular, prudent, starter and high end; said search results allow a buyer to buy, compare prices or post the need to a competitive market place.

13. An apparatus as in claim 11 wherein said marketplace offers multiple ways for a buyer to buy a need; said multiple ways includes searching product market place to find, compare, buy or post need to the competitive process or searching on the internet to become knowledgeable about a product; said multiple ways includes a product view with guiding information and guide selection providing market competitive information, comparing prices, posting need to a competitive process or buying immediately; said multiple ways includes buying from a store view; said multiple ways includes buying from the competitive process view which is a reverse auction process.

14. An apparatus as in claim 13 wherein said store view shows products from a merchant, provides option to buy from the merchant, said marketplace with store view provides the buyer access to their favorite stores.

15. An apparatus as in claim 13 wherein said competitive process view allows a need to be posted to a competitive market with a reverse auction process with guiding information and guide selections; said reverse auction process allows a plurality of sellers to bid on the need, each bid lower than the last bid, and allows the buyer to buy at a reasonable price.
